(19) United States
(12) Patent Application Publication
(10) Pub. No.: US 2010/0038181 A1
(43) Pub. Date: Feb. 18, 2010

(54) PORTABLE LIFT

(76) Inventor: Bradley Gene Jones, Swannanoa, NC (US)

Correspondence Address: TURNER PADGET GRAHAM & LANEY, P.A., P.O. BOX 1509, GREENVILLE, SC, 29602, US

(21) Appl. No.: 12/533,478

(22) Filed: Jul. 31, 2009

Related U.S. Application Data
(60) Provisional application No. 61/085,324, filed on Jul. 31, 2008.

(51) Int. Cl. B66B 9/16; B66B 9/04

(52) U.S. Cl. 187/243; 187/244; 414/800; 414/814

(57) ABSTRACT

A portable lift is provided, the lift having a base, a lift arm, an elevator movably connecting the lift arm to the lift, and detachable wheels attached to the base. A hydraulic pump is in communication with the elevator, and a power drive is used to power the hydraulic pump. The portable lift may be towed or pulled behind a support vehicle, such as a truck or van. A method of operating the portable lift includes positioning the lift on a surface, detaching the wheels to expose an entry side of the lift to a surface, extending a stabilizer to the surface, conveying a vehicle onto the lift through the side entry, engaging the vehicle with the lift arm, and moving the lift arm with the elevator from a resting position on the base to a service position to provide standing room for a service technician beneath the vehicle.

### CROSS-REFERENCE TO RELATED APPLICATIONS

This application is a non-provisional application, claiming priority to and the benefit of U.S. Provisional Application Ser. No. 61/085,324, filed Jul. 31, 2008, the disclosure of which is hereby incorporated by reference in its entirety.

### TECHNICAL FIELD

The present disclosure relates to the lifting of vehicles and, more particularly, to mobile lifting assemblies. Processes for operating such mobile lifting devices are also provided.

### BACKGROUND

The word “vehicle”, as used generically herein, refers to road vehicles (such as cars, trucks and motorcycles), marine crafts (such as boats and personal watercrafts), off-road and all-terrain vehicles, and the like, which may be lifted by embodiments of the present disclosure for maintenance or other reasons. On such occasions, it may be desirable to elevate the vehicle above its normal use surface (e.g., a road or water surface) to access certain features or to view the vehicle in its entirety. Mechanical and hydraulic lifts are commonly used for these purposes. Because many of these known lifts require permanent attachment to a surface (e.g., a service bay) for stability, the vehicle owner is required to transport the vehicle to the service bay for maintenance.

Alternately, several traveling maintenance facilities have been developed for transporting mechanics and their supplies from one location to another, thereby increasing the convenience to the vehicle owner. One type of mobile servicing facility is disclosed in U.S. Pat. No. 5,833,294 to Williams, et al. (the '294 patent). The '294 patent discloses a tractor trailer, which has been outfitted as a multi-bay service facility. Because of its size, this system requires a large amount of space for maneuvering the facility at a work site, which may prevent the facility from being used in highly-populated areas.

Another known mobile facility is swing-link trailer as disclosed in U.S. Pat. No. 4,724,875. This reference discloses a trailer-mounted portable facility for servicing a vehicle. The portable facility includes a controlled lift whose lifting height is restricted by a fixed fulcrum arrangement, and whose access is limited to a rear entry.

U.S. Pat. No. 6,173,941 describes a vehicle mobile service trailer with side access entry, in which the wheels of the trailer are pivotally mounted. This pivotal mounting of the wheels allows the trailer to be lowered to the ground and into an operating position. However, this same pivotal mounting complicates and adds costs to the lift construction.

A number of mobile oil change services have also been introduced in various locations across the United States, which operate from the back of a van or a box truck. These services require the service technician or mechanic to perform the oil change in a prone position, lying under the vehicle to be serviced, much as an individual would perform his own oil change. Clearly, such a practice is inconvenient for the service technician, and limits the amount of additional work that may be performed, in the event that the technician identifies other mechanical problems with the vehicle.

Accordingly, there is a market need for a mobile vehicle lift, which is easy to assemble and to operate and which is capable of being used in relatively confined areas. Further, there is a need for a mobile lift capable of raising a vehicle to a sufficient height for a service person to stand beneath the vehicle. The present disclosure responds to such needs.

### SUMMARY

The present disclosure provides a mobile lifting apparatus having a trailer body with detachable wheels, which is easily transformed from a travel configuration to a service configuration. In the travel configuration, the lift may be pulled behind a towing device to a desired work-site. On location, the wheels are disengaged, and the lift is stabilized to produce a stable service configuration. In the service configuration, a vehicle may be driven onto the lift from a side-entry access point. The arms of the lift elevate the vehicle to a comfortable service position, which may be above the head of a standing mechanic or technician. Because of its compact size, the mobile lift may be easily used and repositioned even within cramped areas.

According to one aspect, the portable lift includes a base having an entry side, a towing side, and an upper face, the base further having a connector removably attached thereto; a lift arm having a forward end and a rearward end, the forward end being connected to the base, and the rearward end being configured to elevate a vehicle from a resting position on the base to a maintenance position between the base and an extended position, a power drive positioned on the lift and being in communication with the lift arm, the power drive being configured to power the lift arm; a wheel attached to the lift, the wheel being configured such that, when the wheel is in a travel position, the lift is capable of traveling along a surface, and, when the wheel is in a disengaged position, the entry side is exposed, whereby a vehicle conveyed onto the lift through the entry side is positioned over the lift arm.

According to another aspect, the portable lift includes: a base defining a perimeter, the perimeter having a towing end with a connector and opposing sides joined to the towing end, the opposing sides defining a wheel axle receiver therethrough, and the base further having an upper surface, the upper surface defining openings therethrough, the openings being located along the upper surface proximate the wheel axle receivers and bisecting the wheel axle receivers; a plurality of posts having a top and a bottom, the bottom of each post being affixed to, and extending vertically from, the base; a lift arm connected to each post, the lift arms being configured to engage and support a vehicle, as the vehicle is moved between a resting position proximate the upper surface of the base and a service position between the base and the top of the post; an elevator connected to and moving each lift arm; and a pair of wheels, each of the wheels having a wheel axle projecting therefrom and being configured to slidably engage a corresponding wheel axle receiver, each of the wheel axles further defining an aperture therethrough and further having a pin, the pin being sized to fit through the opening in the upper surface of the base and the aperture in the wheel axle receiver, such that, when the pin is inserted through the opening and the aperture, the wheel is secured to the base, and, when the Din is removed from the opening and the aperture, the wheel is permitted to be removed from the base.

Finally, a method of using the portable lift is also provided, in which the method includes positioning the lift with a detachable wheel on a surface; detaching the wheel for exposing an entry side of the lift; lowering the lift to contact the surface; extending a plurality of stabilizers from a base to the surface; conveying a vehicle onto the base through the exposed entry side of the lift; engaging a vehicle with a lifting arm; and moving the lift arm with an elevator movably connected to the lift arm between a resting position on the base and a service position between the base and a top of a post extending from the base.

### BRIEF DESCRIPTION OF THE DRAWINGS

These and other aspects of the present disclosure will become apparent to those skilled in the art after a reading of the following description of the preferred embodiment when considered with the following drawings:

FIG. 1 is a side perspective view of a mobile lift, in which the lift is oriented in a travel configuration, according to one aspect of the disclosure;

FIG. 2 is a schematic top view of the lift of FIG. 1;

FIG. 3 is a top view of the lift of FIG. 1, in which the lift is oriented in a service configuration; and

FIG. 4 is a perspective view of the mobile lift of FIG. 1, in which a vehicle to be serviced or inspected is raised by the lift.

### DETAILED DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms. Referring now to the drawings in general, it will be understood that the drawings (including engineering illustrations and photographs) are for the purpose of describing embodiments of the invention and are not intended to limit the invention thereto.

As will be described in detail herein, the components of the portable lift are rigid and lightweight for mobility purposes and are made of durable materials to extend its service life.

Briefly, provided herein is a portable lift having a base, a lift arm, an elevator movably connecting the lift arm to the lift, and detachable wheels attached to the base. A hydraulic pump is in communication with the elevator, and a power drive is used to power the hydraulic pump. The portable lift may be towed or pulled behind a support vehicle, such as a truck or van. A method of operating the portable lift includes positioning the lift on a surface, detaching the wheels to expose an entry side of the lift to a surface, extending a stabilizer to the surface, conveying a vehicle onto the lift through the side entry, engaging the vehicle with the lift arm, and moving the lift arm with the elevator from a resting position on the base to a maintenance position to provide standing room for a service technician beneath the vehicle.

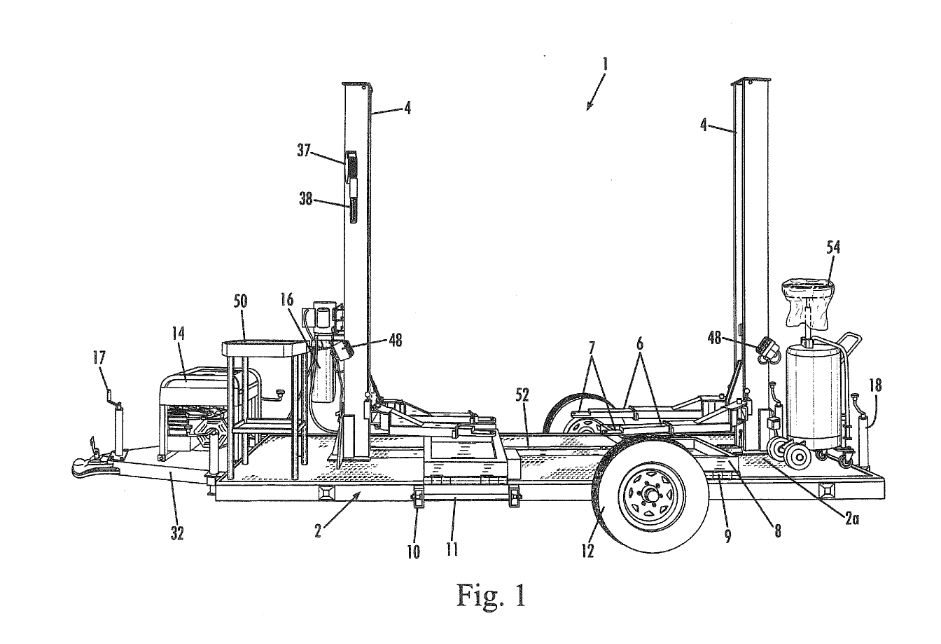

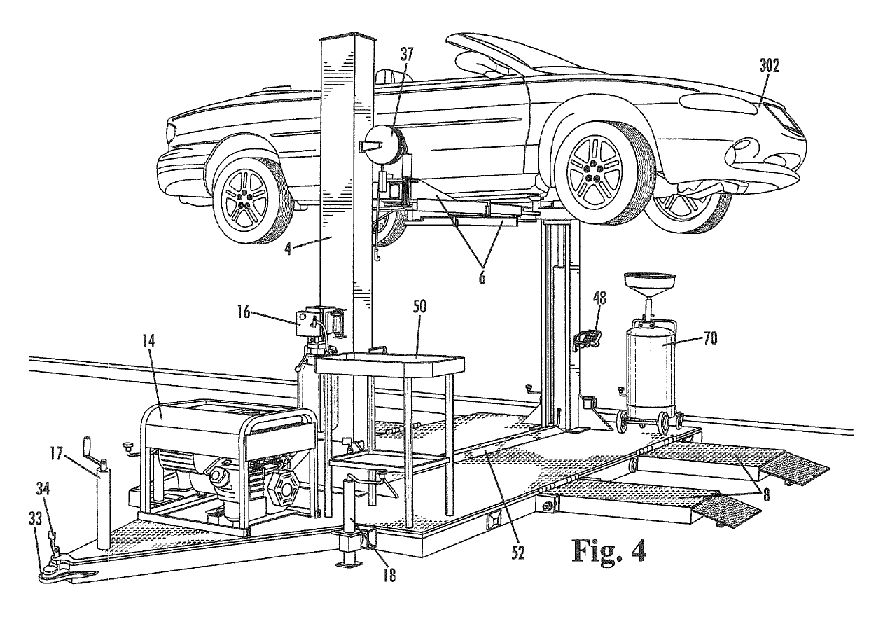

FIG. 1 illustrates a mobile lift 1, which is assembled on a trailer base 2 and which includes lift posts 4, lift arms 6 movably attached to the lift posts 4, and detachably mounted wheels 12. The trailer base 2 has a connector 32, such as a conventional trailer mount having a hitch socket 33 and a tongue 34 (shown in FIG. 4), which permits the lift 1 to be attached to and towed by a support vehicle having a ball hitch, for example. The support vehicle (not shown) may be a box truck, a pick-up truck, a van, or the like, capable of transporting the lift 1 to a chosen work-site.

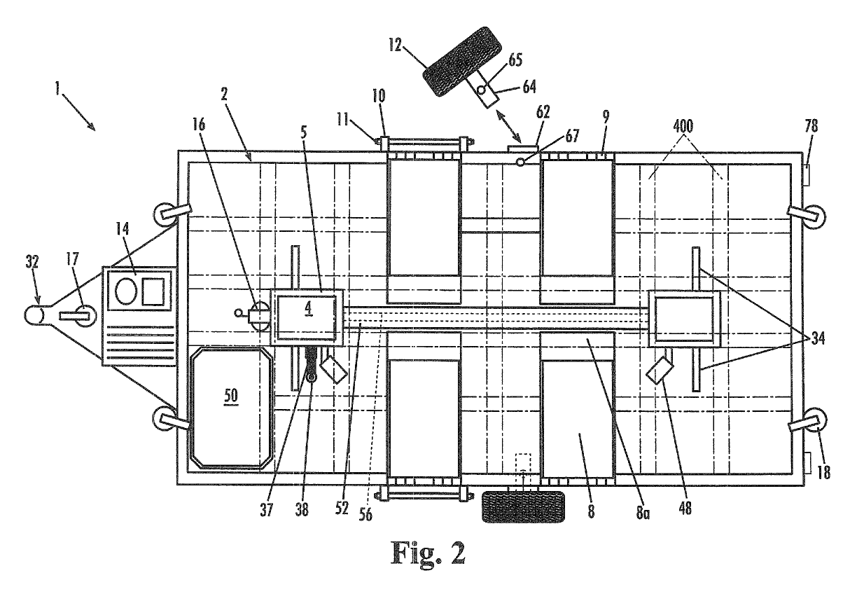

As seen in FIG. 2, the base 2 may be understood to have a towing, or front, end 30, at which end 30 the lift 1 may be connected to a support vehicle for transport, and an opposing, rear end 31. The base 2 has a substantially planar surface with opposing faces, one of which is the upper face 2a that supports the mechanics of the lifting operation and other related and auxiliary components (e.g., table 50). The sheet metal from which the upper face 2a of the base 2 is constructed may be supported by a lattice 400 (shown in broken lines in FIG. 2) of square tubular steel pipes. Alternately, the upper face 2a of the base 2 may be made of, or supported by, a continuous planar sheet.

The base 2 may be made of any one of a variety of materials and may be shaped and sized to meet the structural needs and aesthetic desires of the user. The material of the base 2 is a relatively lightweight material that possesses the rigidity and durability necessary to maintain the structural integrity of the lift 1 during operation. In one example, the base 2 (that is, both lattice 400 and the upper surface 2a) is constructed from steel or a similar alloy.

As shown in the Figures, the base 2 defines a generally rectangular perimeter, having two longitudinal sides that are substantially perpendicular to the towing end 30 and the rear end 31. Although round, oval, triangular, or other shapes may instead be used, the rectangular shape has been found to offer the greatest surface area for the lift and its auxiliary equipment and/or tools. In some circumstances, such as where the lift 1 is being used in crowded or confined spaces, it may be desirable for the towing side 30 and the rear end 31 to be interchangeable. Said differently, it may be more convenient for the operator of the lift 1 to connect the rear end 31 of the lift 1 to the support vehicle, in which case the connector 34 mechanism may be removed from the forward end 30 of the base 2 and reattached to the rear end 31 of the base 2, for example, by securing bolts (not shown) through correspondingly placed attachment holes (not shown) in the rear end 31 of the base 2.

According to one aspect, the width of the base 2 may be from about 65 inches to about 100 inches, and the length of the base may be from about 144 inches to about 216 inches. Alternately, the base 2 may be configured to accommodate two vehicles on the lift at a time. In this embodiment, the length of the base 2 may be substantially longer, for example, up to double the length.

The wheels 12 of the lift 1 may be attached to, and then easily detached from, the base 2, using a mechanism illustrated schematically in FIG. 2. This mechanism permits the lift 1 to be easily transformed from a travel configuration, in which the wheels 12 are engaged with the underlying road surface, to a service configuration, in which the wheels 12 are disengaged from the base 2. In the service configuration, the removal of the wheels 12 permits the base 2 to be lowered to ground level, thereby preparing the lift 1 for the side entry of vehicular traffic. When the lift 1 is in the service configuration, the base 2 may be in full contact, partial contact, or slightly raised from the work-site surface (e.g., parking lot or ground), depending on the height and size dimensions of the vehicle to be serviced and the contour or other restrictions of the surface on which the lift 1 is parked.

The wheels 12 are axially connected at opposing sides of the lift 1 for supporting the lift 1 above a surface, when in the travel configuration (as shown in FIG. 1). As shown in FIG. 2, the wheels 12 are provided with a wheel axle 64. The wheel axle 64 projects from the central portion of one side of the wheel 12, and an aperture 65 is created a prescribed distance from the wheel 62. Each longitudinal side of the base 2 is provided with a wheel axle receiver 62, in the form of a correspondingly sized cylindrical sleeve, for receipt of the wheel axle 64. The upper surface 2a proximate the wheel axle receiver 62 is also provided with an opening 67, which aligns with the aperture 65 in the wheel axle 64. The openings 65, 67 may be formed through the entirety of the respective axle 64 and base 2, and the opening 67 may be positioned to bisect the wheel axle receiver 62. In one aspect, the wheel axle 64 and the wheel axle receiver may protrude inward of the longitudinal sides of the base 2 by a distance of about 1 inch to about 3 inches.

To prepare for transport, the wheel axle 64 is inserted into the wheel axle receiver 62, and a spring pin or other rod (not shown) is inserted through the opening 67 and the axle aperture 65 to rotatably secure the wheel 12 to the base. When the lift 1 arrives at the work-site destination, the lift 1 may be elevated (for example, using tongue jack 17 and/or stabilizer jacks 18), and the spring pin removed, so that the wheels 12 may be separated from the base 2.

The jacks 17, 18 may be adjustable swing jacks, which are sufficiently strong to maintain the lift 1 in a service configuration, prior to and during such times as the vehicle 302 may be lifted above the base 2 of the lift 1. Accordingly, the jacks 17, 18 may be mechanically (e.g., spring) operated or hydraulically operated. The jacks 17, 18 may be adjustable, both vertically and laterally, to provide greater flexibility in the areas in which the lift 1 may be used. Because the jacks 17, 18 are independently adjustable, the lift 1 may be easily stabilized, even on surfaces that may be sloped or otherwise uneven from one side of the lift 1 to the other. The jacks 17, 18 may additionally include a locking device, such as a ping, spring, or similar element.

Although the drawings show a single wheel 12 attached to each longitudinal side of the lift 1, two or more wheels 12 may be attached, in spaced relation to one another, to lift 1. For example, the lift 1 may have four wheels 12, each with its own wheel axle 64 and corresponding axle receiver 62.

Alternately, according to another aspect (not shown), the wheels 12 may be pivotally attached to the base 2. In this instance, the wheels 12 may be attached to a hinge mechanism, which, in an unlocked state, permits the wheels 12 to be folded beneath the base 2, thereby creating the same side entry achieved with the axle construction. The hinge mechanism is locked in the travel configuration.

Advantageously, either of the longitudinal sides of the base 2 may function as an entry side to allow a vehicle 302 to be conveyed onto the lift 1 (as shown in FIG. 4). Because vehicles may approach the lift 1 from either of the longitudinal entry sides on the base 2, the lift 1 has greater accessibility for both the ingress and egress of vehicles 302. Vehicles 302 may be transported over the entry sides in a direction parallel to the towing side 30 and transverse to the longitudinal sides, or vehicles may approach the lift 1 from a slight angle, if necessary, to avoid obstacles which may be in the proximity of the lift 1. Such flexibility permits the lift 1 to be used in locations where space surrounding the lift 1 may be limited (such as, for example, a congested parking lot).

When the lift 1 has been transported to the desired work-site location, such as a parking lot, the wheels 12 are removed, and the lift 1 stabilized, using a plurality of stabilizer jacks 18. The stabilizer jacks 18 may be located at the ends 30, 31 of the base 2, or at any other location deemed necessary. The stabilizer jacks 18 may be retracted, when not in use and when the lift 1 is in the travel configuration.

Turning now to the lifting mechanism, each lift post 4 extends from an upper face 2a of the base 2, and includes a jointed lift arm 6 movably connected thereto. An elevator (housed within or attached to each post 4) moves the lift arm 6 from a resting position proximate to the base 2 to a service position between the base 2 and the top of the post 4. The elevator may have a toggle side and a connection side, to which connection side the lift arm 6 may be attached. The elevator may be controlled hydraulically, electronically, or manually, depending on the desired application. Generally, a cylinder, such as a hydraulic cylinder having a piston or cylinder link, is pivotally mounted on the posts 4 and the elevator to cause raising and lowering of the elevator in response to the extension and retraction of the cylinder. The post 4 defines a travel track for the elevator, whose movement is driven by a hydraulic pump 16 that is operably connected to a power drive 14, as will be discussed further herein.

The posts 4 are provided with a bottom plate 5 and are secured, for example, by welding or the like, to the lattice 400 of the base 2 and/or to the upper surface 2a of the base 2. Opposite the bottom plate 5 is the top of the post 4. Although the post bottom 5 is shown as being fixedly attached to the base 2, it should be understood that the post bottom 5 may be secured to any location on the lift 1 using a variety of connections, including fixed attachment, movable attachment, repositionable attachment, or a combination thereof. If desired, one or more braces 34 may be affixed to the exterior or the interior of the post 4 in a manner designed to restrict the lateral movement of the post 4, which might otherwise occur when the lift 1 is in a travel configuration or when a vehicle (302) is being lifted.

The positioning of the posts 4 along the base 2 defines a centralized lifting zone, and the height of the posts 4 defines the maximum maintenance position that may be achieved. The height of the post 4, by way of example only, may be from about 100 inches to about 150 inches, such that a mechanic or similar service technician may stand beneath the lifted vehicle. Alternately, the height of the post 4 may be substantially larger or smaller to meet the height requirements for a vehicle (304) with unique size and height dimensions or the intended purpose of lifting the vehicle 304.

As illustrated in the Figures, the lift 1 typically includes two posts. However, more than two posts may be employed (for example, across the width of the lift 1) to increase the lifting strength of the lift 1 for heavier or wider vehicles. Alternately, if the length of the base 2 is extended, additional posts 4 may be provided (for example, along the length of the lift 1) to permit multiple vehicles to be lifted at one time.

The lift arms 6 are transported up and down the posts 4 through an electrical and hydraulic connection to the power drive 14 and the hydraulic pump 16. The power drive 14 is positioned on the lift 1, either movably or immovably, and is in communication with the hydraulic pump 16. The hydraulic pump 16 and the power drive 14 are configured in a manner well-known to those skilled in the art. Although the power drive 14 is illustrated and described as an electrical generator, a cable and winch assembly mounted to the base 2 and to the lift arm 6 may instead be used.

Hydraulic cylinders that operate the elevators within the posts 4 are connected, as by tubing or a hose 56, to the power drive 14. The tubing or hosing 56 (shown in broken lines in FIG. 2) is optionally housed on the lift 1 under a protective cover 52. In one embodiment, a center cover 52, as seen in FIGS. 2-4, protects the hydraulic tubing and electrical wires extending from the hydraulic pump 16 and the power drive 14 to the lift posts 4.

Various valves and switches may be used, in a manner well-known to those skilled in the art, to control the hydraulic pump 16 and the power drive 14 for operating the lift arms 6 and their hydraulic cylinders. For example, the power drive 14 may optionally comprise an actuator switch to activate movement of the elevator and a limit switch to terminate movement of the elevator.

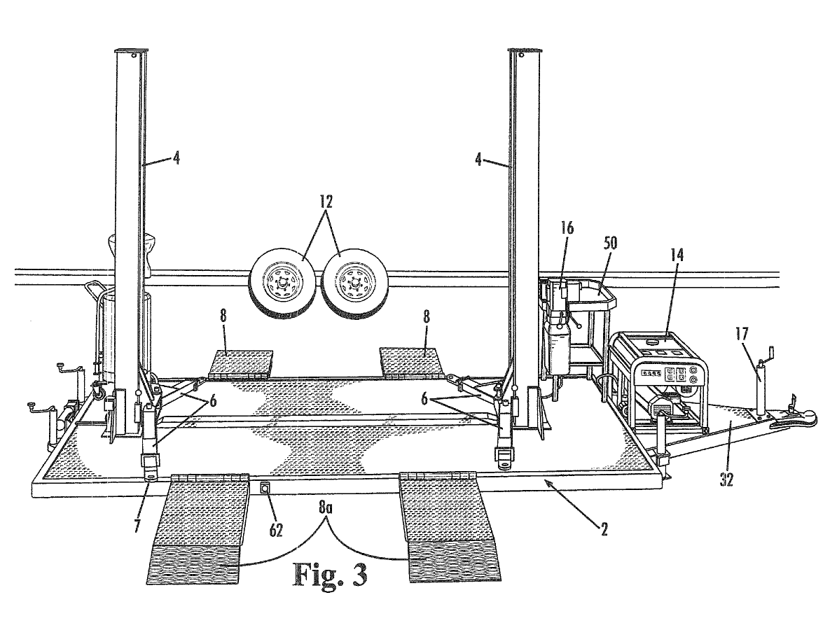

FIG. 1 illustrates the lift 1 in a travel configuration, while FIG. 2 illustrates an intermediate position of the lift 1 (in which one wheel 12 has been removed), and FIGS. 3 and 4 show the lift 1 in a service configuration, in which both wheels 12 have been removed.

In the travel configuration shown in FIG. 1, the wheels 12 are engaged with a wheel axle (shown in FIG. 2) beneath the base 2. Vehicle platforms 8, which are optionally provided to convey the vehicle 302 onto and away from the lift 1, are folded onto the upper surface 2a of the base 2, via hinges 9. When folded thusly, the ramps or platforms 8 are positioned in the lifting zone between the upwardly projecting posts 4 and their corresponding lift arms 6.

While described and illustrated as being hinged and pivotable, the platforms 8 may instead be removable from the base 2. Regardless of their attachment mechanism, the platforms 8 are positioned to facilitate placement of the vehicle (302) between the posts 4. Each platform 8 is connected to the lift 1, typically at the base 2, and is movable from a travel position (as shown in FIGS. 1 and 2, in which the platform 8 is folded onto the upper surface 2a of the base 2) to a service position (as shown in FIGS. 3 and 4, in which the platform 8 is extended from the lift 1 to the contact the ground). Generally, the vehicle 302 to be serviced or inspected travels over the platforms 8 on one side of the lift 1 and stops when the vehicle 302 is positioned over the lift arms 6. Once the vehicle 302 has been serviced or inspected, the vehicle 302 may exit the lift 1 by simply driving over the platforms 8 on the opposite side of the lift 1.

The platforms 8 are typically light-weight to reduce towing restraints and for low volume storage above, within, or below the lift 1. However, the material, size, and dimensions of the platforms 8 are chosen relative to the size and weight of the vehicles 302 to be serviced. In one embodiment, for example only, the width of the platform 8 is about twenty inches and the length is about forty-five inches, terminating in an angled portion 8a (shown in FIGS. 2 and 3). Alternately, the platforms 24 may have other dimensions (for example, a wider width, such that only a single platform 8 is needed for each side). In yet another alternative, the platforms 8 may be electrically powered to facilitate the lifting and lowering thereof.

To increase the stability of the lift 1 in the service configuration, the forward platforms 8 (that is, those platforms closest the towing end 30) may be provided with a platform stabilizer. The platform stabilizer includes a pair of stabilizer brackets 10, through which a stabilizer rod 11 is positioned and secured with a spring-type cotter pin or bolt. The platform stabilizer is shown most clearly in FIGS. 1 and 2.

As shown in FIGS. 3 and 4, the lift arms 6 are arranged to provide an engaging and vehicle support function during operation of the lift 1. (The lift arms 6 have been omitted from FIG. 2 for clarity, but should be understood as being included in the lift 1 as contemplated.) The lift arms 6 are attached to elevators within the posts 4 through a rigid connection, as by welding or the like, which creates a path or travel track for the lift arm 6 to move along the post 4. Alternately, the lift arms 6 may also be removably affixed to the elevator 10, thus allowing the lift arms 6 to be easily detached from the elevator 10 for service and replacement to extend the operational life of the lift 1.

The illustrated arrangement generally comprises a set of lift arms 6 mounted on opposing posts 4, although each post 4 may include a plurality of lift arms 6. For example, in one embodiment, two lift arms 6 may be attached to two opposing posts 4 and spaced about 108 inches apart.

Each lift arm 6 has a contact surface that may be configured in a variety of designs. Preferably, the contact surface of lift arm 6 is flat, and the lift arm 6 is segmented into a V-shape. Alternately, multiple extenders and different shapes may be employed from the lift arms 6, to facilitate the lifting of vehicles having low profiles, running boards, or unconventional chassis shapes.

Additionally, the lift arms 6 may include a receiver 7 to which a rubber or rubber-like pad (not shown) may be mounted to receive and secure the undercarriage surface, chassis, side frame, or the like of the vehicle 302. Instead of a pad, the receiver 7 may include an opening, an indentation, a hook, a clamp, a combination thereof, or the like.

As shown in FIG. 4, an oil drain 70 is optionally positioned, either movably or immovably, on the lift 1 for oil lubricating or similar maintenance services when the vehicle 302 is in the maintenance position. In one embodiment, the oil drain 7 is an air evacuation oil drain, which may be secured to the lift 1 with a telescopic arm or by using a pin-and-socket arrangement or some other mechanism. Optionally, the oil drain 7 may be carried to a work-site in the support vehicle and set up on-site. In FIG. 1, the receptacle portion of the oil drain 7 is covered with a protective covering to prevent the unintended accumulation of rain water, for example, in the collection barrel.

Generally, in the service or maintenance configuration, a mechanic or similar service technician may access the undercarriage, bottom, or sides of the vehicle 302. In a maintenance position in which the lift arms 6 are positioned between the base 2 and the top of the post 4, a worker can stand upright, kneel, squat, or the like, under the lift arms 6 while servicing or inspecting the vehicle. In addition to vehicle inspection and maintenance, the present lift 1 may also be used to elevate a vehicle for recreational purposes, such as for presentation at a car show or the like.

A plurality and variety of tables 50, lights 38, 48, tail lights 78, covers 52, and other accessories may be positioned along the lift 1 at desired locations. For example, as shown in FIGS. 1, 2, and 4, a portable work light 38 may be hung on a pulley 37 attached to one side of the lift post 4, thus permitting the work light 38 to be extended and then the cord to be retracted for convenience. The lights 38, 48, the tail lights 78, and other accessories may be battery operated, fueled by the power drive 14, or powered through conventional electrical connections provided from the towing, or support, vehicle.

In one particular variation of the above-described lift (not shown), the lift arm 6 is retractably connected to the lift 1, preferably to the base 2, and elevates the vehicle 302 without a post 4. In this embodiment, the forward end of the lift arm 6 may be connected, as by welding or the like, to the base 2, and the rearward end of the lift arm 6 is a collapsible link configured to extend and elevate a vehicle 302 from a resting position on the base 2 to a maintenance position between the base 2 and a fully-extended position. According to one aspect, the collapsible link folds upon itself, while, in another aspect, the collapsible link retracts into a hydraulic cylinder. The material, size, and dimensions of lift arm 6 in this embodiment correspond with the size and weight of vehicle 302.

In yet a further expression of the disclosure, not illustrated, the posts 4 may be oriented along the longitudinal sides of the base 2, thus creating a rear-entry lift. In this embodiment, a vehicle (302) may be transported onto the lift from an end opposite the towing end and, as before, be raised by the lift arms 6 attached to the posts 4. The power drive 14 may be located along the connector 32, and the hydraulic pump 16 may be oriented proximate to one of the vertical surfaces of the post 4. The tubing for the hydraulic line may be attached to the post 4 and may be threaded from the pump 16 beneath, or over, the base 2 to the power drive 14.

The above detailed description illustrating the preferred embodiment of the invention is offered for the purpose of promoting an understanding of the present invention. It will nevertheless be understood that no limitation of the scope of the invention is thereby intended as it will be evident to those skilled in the art that the invention may be applied to other mobile lifting without departing from the scope of the present invention.

That which is claimed is:

1. A portable lift comprising:
a base defining a perimeter, the perimeter having a towing end with a connector and opposing sides joined to the towing end, the opposing sides defining a wheel axle receiver therethrough, and the base further having an upper surface, the upper surface defining openings therethrough, the openings being located along the upper surface proximate the wheel axle receivers and bisecting the wheel axle receivers;
a plurality of posts having a top and a bottom, the bottom of each post being affixed to, and extending vertically from, the base;
a lift arm connected to each post, the lift arms being configured to engage and support a vehicle, as the vehicle is moved between a resting position proximate the upper surface of the base and a service position between the base and the top of the post;
an elevator connected to and moving each lift arm; and
a pair of wheels, each of the wheels having a wheel axle projecting therefrom and being configured to slidably engage a corresponding wheel axle receiver, each of the wheel axles further defining an aperture therethrough and further having a pin, the pin being sized to fit through the opening in the upper surface of the base and the aperture in the wheel axle receiver, such that, when the pin is inserted through the opening and the aperture, the wheel is secured to the base, and, when the pin is removed from the opening and the aperture, the wheel is permitted to be removed from the base.

2. The lift of claim 1, further comprising a hydraulic pump positioned on the lift and in communication with the elevators.

3. The lift of claim 2, further comprising a power drive positioned on the lift, the power drive being configured to power the hydraulic pump.

4. The lift of claim 3, wherein the power drive is an electric generator.

5. The lift of claim 3, wherein the power drive is a cable and winch assembly mounted to the base and to the lift arm.

6. The lift of claim 3, wherein the power drive includes an actuator switch.

7. The lift of claim 6, wherein the power drive further includes a limit switch to terminate movement of the elevators.

8. The lift of claim 1, wherein the connector is a tongue having a distal socket to receive a towing hitch.

9. The lift of claim 1, wherein the connector is removably attached to the lift.

10. The lift of claim 1, further comprising a plurality of stabilizers, the stabilizers being located along the perimeter of the base.

11. The lift of claim 1, further comprising a tongue jack, the tongue jack being positioned at the towing end of the lift.

12. The lift of claim 1, further comprising a platform being hingedly connected to the perimeter of the base, the platform being configured to fold onto the base when the wheel is secured and to extend outwardly from the base when the wheel is removed.

13. The lift of claim 12, further comprising a first stabilizer bracket, a second stabilizer bracket, and a stabilizer rod, the stabilizer brackets being affixed to the base on each side of the platform, such that, when the platform extends outwardly from the base, the stabilizer rod is threaded through the first stabilizer bracket, the platform, and the second stabilizer bracket.

14. The lift of claim 1, wherein the post is sufficiently tall to permit a mechanic to stand beneath a vehicle in the service position.

15. The lift of claim 1, further comprising an oil evacuation drain.

16. A portable lift comprising: a base having an entry side, a towing side, and an upper face, the base further having a connector removably attached thereto; a lift arm having a forward end and a rearward end, the forward end being connected to the base, and the rearward end being configured to elevate a vehicle from a resting position on the base to a maintenance position between the base and an extended position, a power drive positioned on the lift and being in communication with the lift arm, the power drive being configured to power the lift arm; a wheel attached to the lift, the wheel being configured such that, when the wheel is in a travel position, the lift is capable of traveling along a surface, and, when the wheel is in a disengaged position, the entry side is exposed, whereby a vehicle conveyed onto the lift through the entry side is positioned over the lift arm.

17. A method of operating a portable lift, the method comprising: positioning the lift with a detachable wheel on a surface; detaching the wheel for exposing an entry side of the lift; lowering the lift to contact the surface; extending a plurality of stabilizers from a base to the surface; conveying a vehicle onto the base through the exposed entry side of the lift; engaging a vehicle with a lifting arm; and moving the lift arm with an elevator movably connected to the lift arm between a resting position on the base and a service position between the base and a top of a post extending from the base.

18. The method of claim 17, further comprising extending a platform from the base, the platform being hingedly connected to the base, and the conveying of a vehicle onto the base occurs via the platform.

19. The method of claim 17, further comprising positioning an oil evacuation drain beneath the vehicle.

20. The method of claim 17, further comprising providing the lift with a power drive and a hydraulic pump, the hydraulic pump communicating with the elevator and the power drive supplying power to the hydraulic pump.
